(19) United States
(12) Patent Application Publication
(10) Pub. No.: US 2007/0061390 A1
(43) Pub. Date: Mar. 15, 2007

(54) Interpolator using splines generated from an integrator stack seeded at input sample points

(76) Inventor: Leo Bredehoft, Longmont, CO (US)

Correspondence Address: TENSORCOMM, INC., 1490 W. 121ST AVE., SUITE 202, WESTMINISTER, CO, 80234, US

(21) Appl. No.: 11/223,713

(22) Filed: Sep. 9, 2005

(51) Int. Cl. G06F 7/38

(52) U.S. Cl. 708/290

(57) ABSTRACT

An interpolator comprises a delay line, a state-variable computer coupled to the delay line and configured to compute initial conditions for at least one interpolation interval, an integrator stack coupled to the state-variable computer and configured to process the initial conditions, and a direct load of state variables for producing a sequence of interpolated output samples. The interpolator's filter order and polynomial order may be selected independently. The filter order may exceed the polynomial order. The state-variable computer may be made computationally efficient in order to approximate general interpolator designs.

### BACKGROUND

1. Field of the invention

The present invention relates generally to methods and circuits for performing digital sample rate conversion. More particularly, the present invention relates to a method and circuit for performing digital interpolation of signal samples using a state-variable computer and an array of integrators.

2. Discussion of the Related Art

An interpolator is a digital electronic circuit typically used to increase the sampling rate of data. In particular, an interpolator estimates one or more interpolated values between two successive sampled data values. There are several types of conventional interpolators, including finite impulse response (FIR) interpolators, half-band interpolators, cascaded integrator-comb (CIC) interpolators, and polynomial interpolators.

FIR interpolators typically require many multipliers and adders, which increase circuit complexity and cost. CIC interpolators may also require a large number of adders, and full precision is typically required in the integrator section of the circuit. Low-order polynomial interpolators (such as quadratic interpolators) may be implemented using a small number of multipliers. However, a quadratic interpolator may have relatively poor aliasing rejection. The desirability of implementing a digital interpolation circuit having an optimal combination of good performance and minimal complexity for minimizing circuit cost and size is well known in the art.

### SUMMARY OF THE INVENTION

In view of the foregoing background, embodiments of the present invention may provide an interpolator and related methods wherein the interpolator provides good performance, but which is also relatively simple in circuit requirements, such as the number of multipliers.

In one embodiment, an interpolator comprises a delay line, a state-variable computer coupled to the delay line and configured to compute initial conditions for seeding an interpolation, and an integrator stack coupled to the state-variable computer and configured to process a direct load of initial conditions for producing interpolated sample values. An interpolator having a polynomial order K interpolates M points between each data point. The interpolator includes K integrators whose initial conditions are seeded from an (N+1)-tap delay line or memory stack at a rate 1/M times the integration rate. The value N is the filter order, which represents the maximum delay (in samples) used in creating each set of K+1 initial conditions. The filter order N of the interpolator need not be directly related to the polynomial order K, but rather, it may be adapted. Typically, the filter order N exceeds the polynomial order K. However, in some embodiments, the polynomial order K may exceed the filter order N. A related method embodiment of the invention may provide for interpolation wherein the filter order is selected as part of a procedure to provide for a predetermined filter response for an interpolator having a given polynomial order.

An interpolator according to an embodiment of the invention may include a means for generating a low-rate sequence of sample values. Initial conditions or state variables are computed from the sample values at an up-sample rate 1/M for input to an interpolator stack. A means for computing initial conditions may process each sample in the delayed input sample stream for processing by a means for performing integration. A means for direct loading of state variables into the means for performing integration may also be included. In an embodiment of an interpolator having polynomial order K, the means for performing integration comprises K+1 registers, the means for computing initial conditions provides K+1 outputs to the means for performing integration, and the means for generating a plurality of delayed samples includes a plurality N+1 of delay components that is typically greater than K+1. However, the plurality of delay components may be less than K+1. The means for direct loading of state variables may or may not be included in this embodiment.

In another embodiment of the invention, for any given up-sample rate M, an interpolator's filter order N and polynomial order K may be selected independently. The filter order N may exceed the polynomial order K. In some cases, the polynomial order K may exceed the filter order N.

Various functional elements, separately or in combination, depicted in the Figures may take the form of a microprocessor, digital signal processor, application specific integrated circuit, field programmable gate array, or other logic circuitry programmed or otherwise configured to operate as described herein. Accordingly, the interpolator may take the form of programmable features executed by a common processor or discrete hardware unit.

These and other embodiments of the invention are described with respect to the figures and the following description of the preferred embodiments.

### BRIEF DESCRIPTION OF THE DRAWINGS

Embodiments of an interpolator according to the present invention are understood with reference to the waveform diagrams of FIGS. 1A-1E, the schematic block diagram of FIG. 2, and the flow diagrams of FIGS. 3 and 4.

FIG. 1A is a waveform diagram that illustrates two specified points, or samples in a discrete-time sequence {(y[Mn]} (e.g., y[Mj] and y[(M+1)j]).

FIG. 1B is a waveform diagram that illustrates a linear spline interpolation between the two specified points that employs a first-order polynomial (i.e., a straight line).

FIG. 1C is a waveform diagram that illustrates a parabola that employs a second-order polynomial.

FIG. 1D is a waveform diagram that illustrates a cubic doublet that employs a third-order polynomial.

FIG. 1E is a waveform diagram of a spline generated from a superposition of waveforms shown in FIGS. 1B, 1C, and 1D that interpolates between the two specified points.

FIG. 2 is a schematic diagram of an interpolator in accordance with an embodiment of the invention.

FIG. 3 is a flow diagram that shows a method embodiment of the invention.

FIG. 4 is a flow diagram that shows an alternative method embodiment of the invention.

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A continuous-time signal y(t) is sampled to produce a low-rate sequence {y[Mj]}, where y[Mj]=y(Mt₀j), 1/Mt₀ is the sample rate, and j is an integer. A desired sequence {z[j]} is synthesized at a rate 1/t₀. For purposes of discussion, it is customary to normalize t₀ to 1 and refer to the sample rate as 1/M. In order to obtain the desired sequence {z[j]} from {y[Mj]}, it is necessary to find sequences of interpolated values (i.e., output samples) z[i], where Mj≦i≦M(j+1) for all values of j.

An interpolation polynomial of order K is given by
P(x, α̅)=α_{K}x^{K}+α_{K-1}x^{K-1}+ . . . +α₁x+α₀,
wherein the terms αₖ represent coefficients and the variables x may express sample indices i. For example, an interpolated data value may be expressed by
z[i]=P[i, α̅[j]], Mj≦i≦M(j+1),
where α̅[j] denotes the polynomial coefficients determined by y[Mj] and y[M(j+1)]. Embodiments of the invention may produce interpolated values z[i] using a polynomial interpolation of order K of the low-rate sequence {y[Mj]}.

Discrete polynomial interpolations P[i] of order K may be recursively described in terms of P^{(K)}[i] (which denotes the K^{th} discrete derivative, or difference, of P and is constant over the interpolation interval) and the initial values of all lower-order derivatives P^{(k)}[i] for which k=(K−1), . . . ,0. The highest-order nonzero derivative of the polynomial P is constant over the interpolation interval, and is denoted by
P^{(K)}[i]=P^{(K)}[Mj], for all Mj≦i≦M(j+1).
Each derivative may be computed via a difference equation that uses the next-higher-order derivative as a slope to increment in each sample interval:
P^{(kε[K-1.0])}[i]=P^{(k)}[i−1]+P^{(k+1)}[i].
By repeating the linear recursion for successively lower polynomial orders, P is reached at order zero:
P[i]=P⁽⁰⁾[i].

Embodiments of the invention may include interpolators having a Nyquist response, as well as non-Nyquist interpolators. When emulating the response of a low-pass Nyquist filter (such as a raised-cosine filter with a bandwidth of

$${f}_{c} = \frac{{f}_{s}}{2 M} ,$$

where f_{c} is the cutoff frequency, and fₛ is the sampling frequency), the impulse response of the interpolator at any low-rate sampling points contains no non-zero contributions from samples at other low-rate points. Thus, if the filter response is normalized such that the impulse response at zero has a value of one, the input samples y[Mj] may be used without modification in the output stream, and P may be designed to interpolate these points as
P⁽⁰⁾[Mj]=y[Mj].

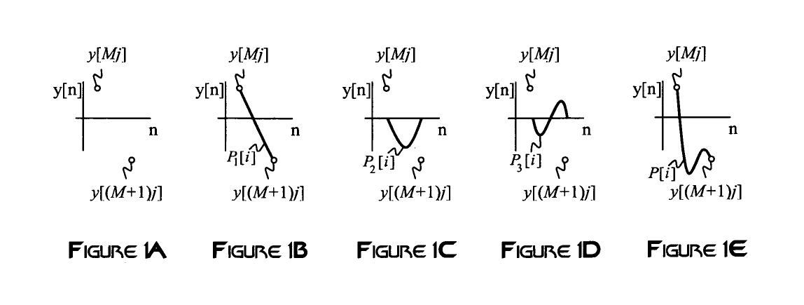

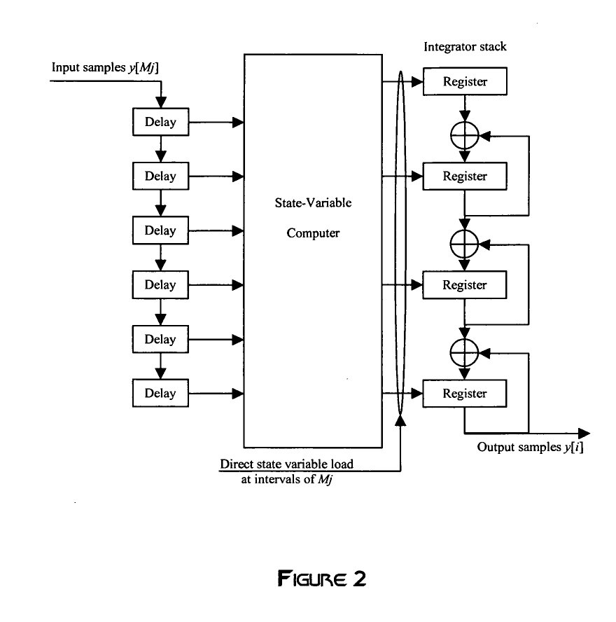

The slope at the endpoint samples may be set equal to the derivative of the filter impulse response at the endpoints. In an embodiment represented by FIGS. 1A-1E, N=3 to satisfy the requirement that P interpolate two specified points (e.g., y[Mj] and y[(M+1)j]) and that P have a specified slope at these points. In this case, the polynomial P may be separated into three components, each of which provides a unique contribution to the slope and value of P:
P[i]=P₁[i]+P₂[i]+P₃[i]
Component P₁ interpolates linearly from Mj to M(j+1 )−1, such as shown in FIG. 1B. FIG. 1C shows that component P₂ generates a parabola, starting and ending at zero, with starting and ending slopes chosen such that their difference is equal to the difference between the slopes commanded by the filter impulse response. In FIG. 1D, component P₃ generates an antisymmetric cubic doublet, also starting and ending at zero, crossing zero at mid-interval and having the same starting and ending slopes.

FIG. 1E shows a superposition of these interpolations, which permits arbitrary value and slope at the endpoints of the interpolation interval, which can be set by selecting initial conditions. P₁ is responsible for setting the endpoint values of the interpolation, while P₂ and P₃ are responsible for endpoint slopes only. These properties permit simple omission of P₂ and P₃, or P₃ alone, to yield lower-order approximations with no change to the lower-order interpolators.

For K=3, the following interpolation relationships may be generated:

$${P}_{k}^{( 2 )} [ i ] = {P}_{k}^{( 2 )} [ 0 ] + {iP}_{k}^{( 3 )} [ 0 ]$$

$${P}_{k}^{( 1 )} [ i ] = {P}_{k}^{( 1 )} [ 0 ] + {\sum }_{l = 0}^{i - 1} {P}_{k}^{( 2 )} [ l ]$$

$${P}_{k}^{( 0 )} [ i ] = {P}_{k}^{( 0 )} [ 0 ] + {\sum }_{l = 0}^{i - 1} {P}_{k}^{( 1 )} [ l ]$$

$$Using the identities$$

$${\sum }_{i = 1}^{k - 1} i = \frac{k ( k - 1 )}{2} and {\sum }_{i = 1}^{k - 1} {i}^{2} = \frac{k ( k - 1 ) ( 2 k - 1 )}{6} ,$$

the lower-order interpolator stage values may be expressed directly in terms of i and initial conditions Pₖ^{(q)}[0]:

$$\begin{matrix}{P}_{k}^{( 1 )} [ i ] = {P}_{k}^{( 1 )} [ 0 ] + {iP}_{k}^{( 2 )} [ 0 ] + \frac{1}{2} i ( i - 1 ) {P}_{k}^{( 3 )} [ 0 ] \\ {P}_{k}^{( 0 )} [ i ] = {P}_{k}^{( 0 )} [ 0 ] + {iP}_{k}^{( 1 )} [ 0 ] + \frac{1}{2} i ( i - 1 ) {P}_{k}^{( 2 )} [ 0 ] + \\ ( \frac{( i - 2 ) ( i - 1 ) ( 2 i - 3 )}{12} + \frac{( i - 2 ) ( i - 1 )}{4} ) {P}_{k}^{( 3 )} [ 0 ] \\ = {P}_{k}^{( 0 )} [ 0 ] + {iP}_{k}^{( 1 )} [ 0 ] + \frac{1}{2} i ( i - 1 ) {P}_{k}^{( 2 )} [ 0 ] + \frac{( i - 2 ) ( i - 1 ) i}{6} {P}_{k}^{( 3 )} [ 0 ]\end{matrix}$$

The previous equations may also be expressed in matrix form as

$$[ \begin{matrix}{P}_{k}^{( 3 )} [ i ] \\ {P}_{k}^{( 2 )} [ i ] \\ {P}_{k}^{( 1 )} [ i ] \\ {P}_{k}^{( 0 )} [ i ]\end{matrix} ] = [ \begin{matrix}1 & 0 & 0 & 0 \\ i & 1 & 0 & 0 \\ i ( i - 1 ) \text{/} 2 & i & 1 & 0 \\ i ( i - 2 ) ( i - 1 ) \text{/} 6 & i ( i - 1 ) \text{/} 2 & i & 1\end{matrix} ] [ \begin{matrix}{P}_{k}^{( 3 )} [ 0 ] \\ {P}_{k}^{( 2 )} [ 0 ] \\ {P}_{k}^{( 1 )} [ 0 ] \\ {P}_{k}^{( 0 )} [ 0 ]\end{matrix} ]$$

This matrix equation demonstrates that each component Pₖ⁽⁰⁾ of the interpolator ouput is a linear function of the initial conditions.

Equations represented by the matrix may employ the interpolation factor M, as well as starting and ending slopes and values required for P₁, P₂, and P₃, to compute initial conditions for an integrator at the beginning of each interpolation interval. The initial value for linear component P₁ of a Nyquist filter is given by P₁⁽⁰⁾[0]=y[Mj], which represents a sample value at the start of the interpolation interval. The initial slope is

$${P}_{1}^{( 1 )} [ 0 ] = \frac{y [ M ( j + 1 ) ] - y [ Mj ]}{M} .$$

In embodiments that employ a filter whose impulse response is not unity at i=0 and zero at i=Mj, the initial conditions for P₁ may be computed by evaluating the filter values at the interpolation interval endpoints and using them instead of the y values.

An expression for P₂ may be derived using an initial value of zero, an initial slope P₂⁽¹⁾[0]=s₂, and an ending slope P₂⁽¹⁾[M+1]of −s₂:

$${P}_{2}^{( 2 )} [ 0 ] = \frac{- 2 {s}_{2}}{( M + 1 )}$$

An expression for P₃ that employs initial and ending values P₃⁽⁰⁾[0]=P₃⁽⁰⁾[M]=0 and initial and ending slopes

$$\begin{matrix}{P}_{3}^{( 1 )} [ 0 ] = {P}_{3}^{( 1 )} [ M - 1 ] = {s}_{3} , yields \\ {P}_{3}^{( 2 )} [ 0 ] = - \frac{1}{2} ( M - 2 ) {P}_{3}^{( 3 )} [ 0 ]\end{matrix}$$

Using appropriate substitutions from previous equations, the following expression is obtained

$${P}_{3}^{( 3 )} [ 0 ] = \frac{12 {s}_{3}}{( M - 2 ) ( M - 1 )}$$

The slopes desired at the start and end of the interpolation interval may be selected simply to be equal to the slopes h[Mj] and h[M] of the prototype (e.g., raised cosine) filter being emulated. From the desired slopes, s₂ and s₃ may be computed by requiring that the P₂ parabola endpoint slopes span the difference between h[Mj] and h[M(j+1)] and requiring that the P₃ doublet endpoint slopes are equal to the slope remaining after the slopes of P₁ and P₂ have been subtracted from the desired slopes

$$\begin{matrix}{s}_{2} = \frac{h [ M ( j + 1 ) ] - h [ Mj ]}{2} \\ and \\ {s}_{3} = h [ Mj ] - {s}_{2} - {P}_{1}^{( 0 )} [ 0 ] .\end{matrix}$$

A complete set of initial conditions for an interpolation interval may be calculated from the previous expressions for s₂ and s₃. A superposition enables initial conditions for P to be set to the sum of the component initial condition values

$${P}^{( q )} [ 0 ] = {\sum }_{k = 1}^{K} {P}_{k}^{( q )} [ 0 ] , 1 \leq q \leq K ,$$

which permits a single integrator to be used rather than the sum of the outputs of multiple integrators.

For an L-lobe linear-phase Nyquist filter whose starting and ending derivatives are zero, the cost of the above computation is only (L−1)/2+4 multiplies per input sample, and is independent of the upsampling factor M. A better match to an arbitrary desired response may be achieved by treating the initial conditions for P₁, P₂, and P₃ as parameters to a numerical optimization designed for that purpose. It should be noted that all initial condition computations described above may amount to no more than the computation of linear combinations of low-rate input samples at the output sample rate.

In hardware implementations that may be sensitive to chained computations, the initial conditions may be computed directly as a matrix multiplication, wherein the matrix coefficients may be derived using at least some of the previous equations or by numerical optimization. Interpolators that use optimization to compute the matrix coefficients have been shown to provide a high-precision emulation of a five-lobe raised cosine filter. When optimal rectangular-spectrum low-pass filtering is the optimization target, very good results may be achieved as well.

Some embodiments of the invention may trade performance for computational simplicity. For example, in the five-lobe case, the initial conditions are computed with the matrix equation

$${[ {P}^{( 0 )} [ Mj ] … {P}^{( K )} [ Mj ] ]}^{T} = {A [ y [ M ( j - 3 ) ] … y [ M ( j + 2 ) ] ]}^{T} , \\ where$$

$$A = \begin{matrix}0 & 0 & 1 & 0 & 0 & 0 \\ {c}_{1} & - 2 {c}_{1} & 0 & 2 {c}_{1} & - {c}_{1} & 0 \\ {c}_{2} & - \frac{3}{2} {c}_{2} & 2 {c}_{2} & - {c}_{2} & 0 & - \frac{1}{2} {c}_{2} \\ {c}_{3} & - {c}_{3} & 2 {c}_{3} & - 2 {c}_{3} & {c}_{3} & - {c}_{3}\end{matrix} .$$

The entire matrix multiplication is characterized by functions of only three constants. Furthermore, the addition operations for each row can be factored out and performed prior to multiplication by the constants. The constant multiplications shown may be implemented as simple shifts, with the exception of the constant 3/2, which requires two shifts and an addition. The performance of interpolators with matrices constrained in this way (i.e., a constrained case) can approach the performance of interpolators having unconstrained matrices. Although the exemplary embodiment may suffer some performance loss, the simplicity of the resulting hardware design can make this embodiment advantageous.

FIG. 2 illustrates an interpolator embodiment of the invention. An input sample stream at rate 1/M is fed through an N+1-length delay line or memory stack whose outputs are processed by an state-variable computer to compute K+1 initial conditions at the input sample rate. The term “delay line,” as used herein, includes equivalent components or processes configured to delay the input sample stream. The maximum delay (or equivalently, the number of input samples) used in computing each initial condition is referred to as the filter order of the interpolator. One or more of the delay components between the first and last delay components may be unused without changing the filter order. Each update of the K+1 initial conditions at rate 1/M resets the order-K integrator stack for an M-sample interpolation at (normalized) rate 1.

An integrator stack, which consists of a cascade of simple registers (each of which is labeled “register”) whose inputs are summed with the register value at the output sample rate, generates an output sample stream at the register corresponding to the lowest polynomial order. This embodiment provides for a direct load of state variables P^{(q)}[Mj], 0≦q≦K into the integrators at the beginning of each sample interval.

The exemplary embodiment shown in FIG. 2 has a filter order of five in which six inputs are provided to the state-variable computer. This interpolator embodiment employs a polynomial order of three. Thus, four inputs are provided to the integrator stack. While a prior-art interpolator having a polynomial order of K processes K+1 inputs to provide for initial conditions, embodiments of the present invention may employ a filter order that exceeds the polynomial order. Thus, the number of delay components (i.e., inputs to the state-variable computer) may exceed the number of stages in the integrator stack. The independence of these two quantities allows a degree of freedom in selecting the polynomial order K and the filter order N that is also independent of the up-sample rate M. Exemplary embodiments of the invention may provide for alternative numbers of delay components and/or filter orders, which may be selected such as to adjust filter shape. The design equations permit an approximation of initial conditions to realize interpolators with nearly arbitrary responses.

FIG. 3 is a flow diagram that shows a method embodiment of the invention. An input sample stream is delayed by a sequence of delay components 301. Initial conditions for each sample are computed from the delayed input sample stream for processing by an integrator stack 302. A direct load of state variables P⁽ⁿ⁾[Mk] is also injected into the integrator stack to control the interpolator trajectory during an M-sample interpolation interval 303 of rate-1 samples.

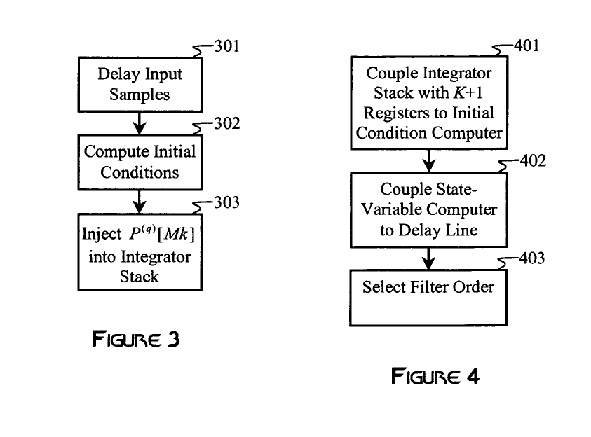

FIG. 4 is a flow diagram that shows an alternative method embodiment of the invention. An interpolator having a polynomial order K is produced by providing for an integrator stack having K+1 registers coupled to K+1 outputs of an state-variable computer 401, providing for coupling the state-variable computer to a delay line comprising a plurality of delay components 402, and selecting the filter order N to be greater than the polynomial order K 403. The filter order of the interpolator may be selected as part of a procedure to provide for a predetermined filter response.

Embodiments of the invention may be employed in sigma-delta digital-to-analog converters, in which data in the digital domain is up-sampled prior to conversion to analog. Since the integrator stack initial conditions may include any number of input samples, various embodiments may provide for filter responses with an arbitrary number of lobes, and thus an arbitrarily sharp cutoff frequency. Also, there is some freedom (via numerical optimization) to approximate target filter response shapes, such as channel-matched filters used in communications. Some embodiments of the invention may be incorporated into sigma-delta digital-to-analog converters to produce channel filters integrated into the interpolation filter.

Logic implementations of embodiments of the invention may be considerably smaller than prior-art interpolators that perform multiple simultaneous multiplies at the output sample rate. In some embodiments of the invention, multiplication is performed only at the low input sample rate. In the constrained case described previously, only three multiplies are required at the sample rate. Because of the low multiplication rate, multiplies may be serialized to save hardware. For example, an embodiment having an up-sample rate M=8 employing a five-lobe constrained matrix multiply with two complete interpolators and simultaneous generation of two output samples per clock cycle may occupy only 24,000 gates when synthesized with the 90-nm TSMC standard cell library.

Various interpolation techniques are described in F. Francesconi, G. Lazzari, V. Liberali, F. Maloberti, G. Torelli, “A Novel Interpolator Architecture for SD DACs,” Department of Electronics, University of Pavia, Via Abbiategrasso, 209-27100 Pavia, Italy, Genova Ricerche, Via dell'Acciaio, 139-16152 Genova, Italy, which is hereby incorporated by reference. Some embodiments of the invention may combine integrators using direct load of state variables and superposition to reduce the size of the integrator stack. Integrator stack interpolation embodiments may be implemented on single-instruction, multiple-data processors, such as the Intel Pentium/SSE2 and other architectures that support multiple simultaneous add operations.

Modem sigma-delta converters use a brick-wall FIR filter or filters, cascaded with one or more sinc³ filters to bring the sample rate from baseband to the modulator rate, which can be from about ten times to several thousand times the baseband rate. Embodiments of the present invention may be used as an adjunct to (or outright replacement of) conventional filtering schemes. For example, a sigma-delta converter may be implemented using a cascade of interpolators based on one or more interpolator embodiments described herein.

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the spirit and scope of the invention as defined by the claims.

1. An interpolator comprising:
a delay line,
a state-variable computer coupled to the delay line and configured to compute initial conditions for at least one interpolation interval, and
an integrator stack coupled to the state-variable computer and configured to process the initial conditions and a direct load of state variables for producing a sequence of interpolated output samples for at least one interpolation interval.

2. The interpolator recited in claim 1, wherein the state-variable computer is configured to compute a matrix multiplication comprising linear combinations of input samples, and produce an output of initial conditions at a rate equal to an input rate of the input samples.

3. The interpolator recited in claim 2, wherein matrix coefficients are derived using at least one of a set including previous equations and numerical optimization.

4. The interpolator recited in claim 2, wherein the state-variable computer is configured to employ at least one of a set of matrices, including a constrained matrix and an unconstrained matrix.

5. The interpolator recited in claim 1 configured to perform a polynomial interpolation of order K, where K is an integer greater than one.

6. The interpolator recited in claim 1 configured to emulate at least one of a Nyquist filter and a non-Nyquist filter.

7. A sigma-delta converter comprising the interpolator recited in claim 1.

8. An interpolation method, comprising:
providing for generating a plurality of delayed samples for producing an input sample stream,
providing for computing initial conditions for each sample in the input sample stream for processing by an integrator stack, and
providing for direct loading of state variables into the integrator stack to control interpolator trajectory during an interpolation interval.

9. The interpolation method recited in claim 8, wherein providing for computing initial conditions comprises computing a matrix multiplication comprising linear combinations of input samples, and producing an output of initial conditions at a rate equal to an input rate of the input samples.

10. The interpolation method recited in claim 9, wherein providing for computing initial conditions comprises at least one of using previous equations and performing numerical optimization to derive matrix coefficients.

11. The interpolation method recited in claim 9, wherein providing for computing initial conditions comprises employing at least one of a set of matrices, including a constrained matrix and an unconstrained matrix.

12. The interpolation method recited in claim 8 configured to perform a polynomial interpolation of order K, where K is an integer greater than one.

13. The interpolation method recited in claim 8 configured to emulate at least one of a Nyquist filter and a non-Nyquist filter.

14. A sigma-delta converter employing the interpolation method recited in claim 8.

15. A digital computer system programmed to perform the method recited in claim 8.

16. A computer-readable medium storing a computer program implementing the method of claim 8.

17. A chipset configured to perform the method of claim 8.

18. An interpolator, comprising:
a means for delaying a plurality of samples for producing an input sample stream,
a means for computing initial conditions for each sample in the input sample stream for processing by a means for performing integration, and
a means for direct loading state variables into the means for performing integration.

19. The interpolator recited in claim 18, wherein the means for computing initial conditions is configured to compute a matrix multiplication comprising linear combinations of input samples, and producing an output of initial conditions at a rate equal to an input rate of the input samples.

20. The interpolator recited in claim 19, wherein matrix coefficients are derived using at least one of a set including previous equations and numerical optimization.

21. The interpolator recited in claim 19, wherein means for computing initial conditions is configured to employ at least one of a set of matrices, including a constrained matrix and an unconstrained matrix.

22. The interpolator recited in claim 18 configured to perform a polynomial interpolation of order K, where K is an integer greater than one.

23. The interpolator recited in claim 18 configured to emulate at least one of a Nyquist filter and a non-Nyquist filter.

24. A sigma-delta converter comprising the interpolator recited in claim 18.

25. An interpolator characterized by a predetermined polynomial order, comprising:
a delay line providing for a predetermined filter order, wherein the filter order is selectable and independent from the polynomial order,
a state-variable computer coupled to each of the delay line and configured to compute initial conditions for at least one interpolation interval, and
an integrator stack coupled to the state-variable computer configured to process the initial conditions for producing a sequence of interpolated output samples.

26. The interpolator recited in claim 25, wherein the filter order is selected to be greater than or less than the polynomial order.

27. The interpolator recited in claim 25, wherein the state-variable computer is configured to compute a matrix multiplication comprising linear combinations of input samples, and to produce an output of initial conditions at a rate equal to an input rate of the input samples.

28. The interpolator recited in claim 27, wherein matrix coefficients are derived using at least one of a set including previous equations and numerical optimization.

29. The interpolator recited in claim 27, wherein the state-variable computer is configured to employ at least one of a set of matrices, including a constrained matrix and an unconstrained matrix.

30. The interpolator recited in claim 25 configured to emulate at least one of a Nyquist filter and a non-Nyquist filter.

31. A sigma-delta converter comprising the interpolator recited in claim 25.

32. A method for performing an interpolation corresponding to a predetermined polynomial order, comprising:
providing for delaying a sequence of input samples with a set of delays corresponding to a predetermined filter order, wherein the filter order is selectable and independent of the polynomial order,
providing for computing initial conditions for at least one interpolation interval, and
providing for processing the initial conditions in an integrator stack for producing a sequence of interpolated output samples.

33. The interpolation method recited in claim 32, wherein providing for delaying includes selecting the filter order to be less than or greater than the polynomial order.

34. The interpolation method recited in claim 32, wherein providing for computing initial conditions is configured to compute a matrix multiplication comprising linear combinations of input samples, and to produce an output of initial conditions at a rate equal to an input rate of the input samples.

35. The interpolation method recited in claim 34, wherein matrix coefficients are derived using at least one of a set including previous equations and numerical optimization.

36. The interpolation method recited in claim 34, wherein providing for computing initial conditions is configured to employ at least one of a set of matrices, including a constrained matrix and an unconstrained matrix.

37. The interpolation method recited in claim 32 configured to emulate at least one of a Nyquist filter and a non-Nyquist filter.

38. A sigma-delta converter employing the interpolation method recited in claim 32.

39. A digital computer system programmed to perform the method recited in claim 32.

40. A computer-readable medium storing a computer program implementing the method of claim 32.

41. A chipset configured to perform the method of claim 32.

42. An interpolator, comprising:
a means for performing integration having a polynomial order K,
a means for computing initial conditions for each sample in a delayed input sample stream and providing K+1 outputs to the means for performing integration, and
a means for delaying a plurality of input samples, wherein the means for delaying is characterized by a filter order that is selectable and independent of the polynomial order K.

43. The interpolator recited in claim 42, wherein the means for delaying is configured to select the filter order to be less than or greater than the polynomial order.

44. The interpolator recited in claim 42, wherein the means for computing initial conditions is configured to compute a matrix multiplication comprising linear combinations of input samples, and to produce an output of initial conditions at a rate equal to an input rate of the input samples.

45. The interpolator recited in claim 50, wherein matrix coefficients are derived using at least one of a set including previous equations and numerical optimization.

46. The interpolator recited in claim 50, wherein the means for computing initial conditions is configured to employ at least one of a set of matrices, including a constrained matrix and an unconstrained matrix.

47. The interpolator recited in claim 42 configured to emulate at least one of a Nyquist filter and a non-Nyquist filter.

48. A sigma-delta converter comprising the interpolator recited in claim 42.
